(19) United States
(12) Patent Application Publication
(10) Pub. No.: US 2010/0170618 A1
(43) Pub. Date: Jul. 8, 2010

(54) CUT-AND-STACK LABEL MADE FROM SHRINK FILM AND RELATED METHODS

(76) Inventors: Sean M. Keeney, Atlanta, GA (US); James D. Combs, Winchester, KY (US); John David Enoch, Mt. Sterling, KY (US)

Correspondence Address: KING & SCHICKLI, PLLC, 247 NORTH BROADWAY, LEXINGTON, KY, 40507, US

(21) Appl. No.: 12/724,031

(22) Filed: Mar. 15, 2010

Related U.S. Application Data
(63) Continuation-in-part of application No. 12/135,609, filed on Jun. 9, 2008.

(51) Int. Cl. B32B 37/14; B32B 3/10; B32B 38/14

(52) U.S. Cl. 156/85; 428/201; 156/277

(57) ABSTRACT

A cut-and-stack label includes a cut-and-stack sheet sized for feeding by cut-and-stack labeling equipment and labeling an individual container. The cut-and-stack sheet includes a first shrink film layer having a first face and a second shrink film layer having a second face. The first face of the first shrink film layer is laminated to the second face of the second shrink film layer. Printing is provided on at least one of the first and second faces. A method of producing cut-and-stack labels and a method of labeling a container are also provided.

This application is a continuation-in-part of U.S. patent application Ser. No. 12/135,609 filed on 9 Jun. 2008.

### TECHNICAL FIELD

The present invention relates generally to the product labeling field and, more particularly, to a cut-and-stack label made from shrink film material, a method of making such a cut-and-stack label and a method of labeling a container.

### BACKGROUND OF THE INVENTION

Consumers have shown a preference for food, beverage, household and chemical products to be packaged in containers offering a number of benefits including, but not limited to, portability, resealability, safety, lightweight and contourability for a comfortable grip in use. These consumers needs have lead to new designs and shaped steel, plastic, glass and aluminum containers.

Shaped container designs with, but not limited to, curved, concave, convex and angular shapes were developed for a wide range of end use markets, and these containers pose challenges for package goods companies and label manufacturers. For shaped containers, consumer package companies prefer labels that are shrinkable, 100% water resistant, scuff resistant, extremely durable, resistant to product deterioration, able to withstand drops up to six feet without tearing and are aesthetically pleasing to the consumers' eye and touch for the life of the use of the container. Further, in many instances it is preferred that the label be made of recyclable material.

Recently, packaged good companies have indicated a preference for shrink wrap packaging. Such packaging provides a number of benefits including, but not limited to, contourability to the container for aesthetic appeal and, in certain applications, added security and tamper resistance. When a shrink film is used in a process to label or wrap a container, heat is applied and the film shrinks around the container producing a tight, transparent or opaque, wrapping that conforms to the contour of the article and provides useful functions required of labeling packaging materials.

Many product packaging lines in existence today incorporate equipment for cut and stack labeling. To date, shrink film packaging materials have only been provided in one of the following formats: un-seamed labels in continuous rolls, seamed labels in continuous rolls or seamed labels individually cut. Such shrink film labels are not adapted for and cannot be used with cut-and-stack labeling equipment. Accordingly, many package goods companies desiring to switch to shrink film labels for their packaging needs are faced with the costly capital expenditure necessary to replace their cut-and-stack labeling equipment with roll feeding equipment not capable of applying cut-and-stack labels. Alternatively, they apply labels individually by hand at very slow and inefficient speeds.

The present invention addresses this problem by providing for the first time cut-and-stack labels made from shrink film packaging materials. This was achieved by; first, producing labels from commercially proven shrink film materials in combination not before achieved using a unique process which eliminates static, and second, the use of non-contact spray hot melt glue systems to apply the labels on containers using cut-and-stack label equipment. As a result, packaged goods companies with cut-and-stack label equipment can now switch to shrink film labels without having to replace that equipment with expensive roll feeding equipment. There are no suitable alternative materials to produce cut-and-stack shrink labels, and roller applied hot melt glue systems are not compatible with cut-and stack shrink labels. Accordingly, the present invention represents a significant advance in the art.

### SUMMARY OF THE INVENTION

In order to achieve the foregoing and in accordance with the purposes of the present invention as described herein, a cut-and-stack label made from shrink film material is provided. The cut-and-stack label comprises a cut-and-stack sheet sized for (a) feeding by cut-and-stack labeling equipment and (b) labeling an individual container. The cut-and-stack sheet includes a first shrink film layer having a first face and a second shrink film layer having a second face. The first face of the first shrink film layer is laminated to the second face of the second shrink film layer. Printing is provided on at least one of the first face and the second face along the lamination interface. This ensures that the printing is protected from scuffing and marring not only during the labeling process, but also downstream during packing, shipping and handling of the consumer product. Typically the label has a width of between about 2″ and about 7″ and a length of between about 7″ and about 24″. Still more typically the label has a width of between about 3½″ and about 4½″ and a length of between about 14″ and about 18″.

In one common embodiment the first shrink film layer is transparent in order to allow the printing of the label to be easily read. The second shrink film layer may be opaque, transparent or translucent. The first and second shrink film layers may be made from oriented polymer shrink film. Typically the shrink film is made from a material selected from a group consisting of polyvinyl chloride, polystyrene, polyester, polyolefin, polypropylene and combinations thereof. In any of the embodiments the exposed face of the cut-and-stack sheet may include an antistat coating and/or a dusting of offset powder. Typically the offset powder is selected from a group of materials consisting of corn starch, baby powder, talc and mixtures thereof.

In accordance with an additional aspect of the present invention a method is provided for producing cut-and-stack labels. The method may be broadly described as comprising the steps of printing indicia on a first face on a first shrink film, laminating the first face of the first shrink film to a second face of a second shrink film to form a sheet, dusting at least one exposed face of the sheet with an offset powder and finishing the cut-and-stack labels. In addition, the method may include the step of applying an antistat to either or both exposed faces of the sheet.

Finally, the invention also includes a method of labeling a container. That method comprises feeding a cut-and-stack label made from at least one shrink film, positioning that cut-and-stack label on the container using a non-contact spray hot melt glue system and shrinking the cut-and-stack label to the container.

Still other benefits and advantages of the present invention will become readily apparent to one skilled in the art from the following description wherein there is shown and described preferred embodiments of this invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is a schematical edge elevational view of a label constructed in accordance with the teachings of the present invention; and

FIG. 2 is a schematical side elevational view illustrating in-line processing steps in order to make cut-and-stack labels of the present invention.

Reference will now be made in detail to the present preferred embodiment of the invention, an example of which is illustrated in the accompanying drawings.

### DETAILED DESCRIPTION OF THE PREFERRED EMBODIMENTS OF THE INVENTION

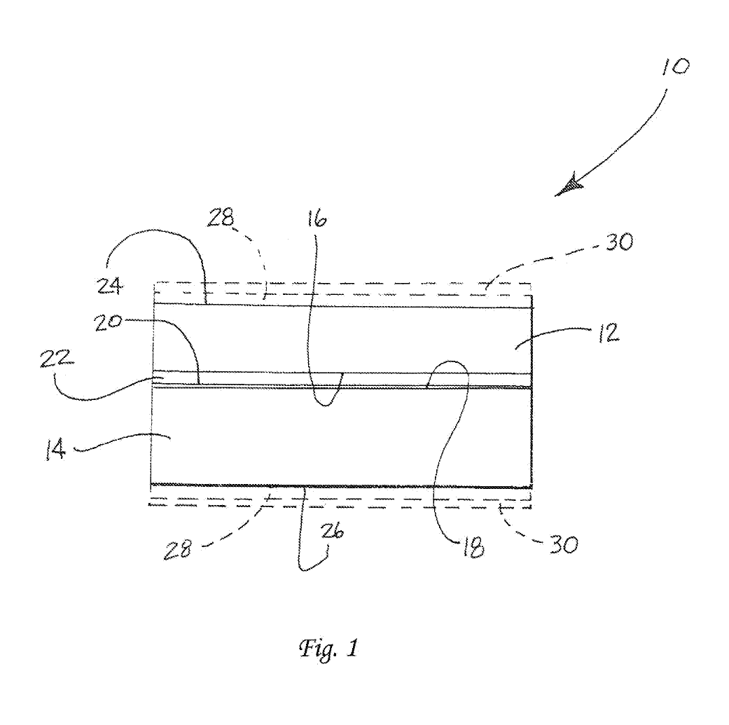

Reference is now made to drawing FIG. 1 clearly illustrating a cut-and-stack label 10 made in accordance with the teachings of the present invention. Such a cut-and-stack label 10 is particularly adapted for use with cut-and-stack labeling equipment. The cut-and-stack label 10 typically is between about 2″ and about 7″ in width and between about 7″ and about 24″ in length. More typically, the cut-and-stack label 10 is between about 3½″ and about 4½″ in width and between about 14″ and about 18″ in length.

The label 10 comprises a first shrink film 12 that is laminated to a second shrink film 14 in a manner described in detail below. Both shrink films 12, 14 may be made from an oriented polymer shrink film of the type known in the art. Such shrink films 12, 14 made from polyvinyl chloride, polystyrene, polyester, polyolefin, polypropylene and combinations thereof provide a wide range of physical and performance characteristics. Such characteristics play an important role in the selection of a film for any particular application. For example, the film selected may exhibit shrinkage in one or more directions from perhaps as little as 5% to as much as 80%. For certain applications shrinkage rates greater than 40% may not be desired. For most cut-and-stack label shrink film applications, shrinkage rates of between 5 and 15% are desired.

Shrink film materials useful for the present invention and commercially available in the market place include, but are not limited to, Vision 270 WMS, a white opaque oriented polypropylene (OPP) film and Vision 255 CMS transparent OPP film manufactured and sold by Applied Extrusion Technologies, Inc. Typically, the films 12 and 14 are between about 2.0 mil and about 3.6 mil in thickness in order to provide the necessary label strength and desired stiffness for feeding by cut-and-stack labeling equipment.

A first face 16 of the first shrink film 12 and/or a second face 18 of the second shrink film 14 is printed with indicia 20 and carries a message in ink or other suitable means. A clear drying adhesive layer 22 is applied to either the first face 16 or second face 18 and the two shrink films 12, 14 are laminated together. For most applications the first shrink film 12 is transparent so as to allow one to easily read the printing 20 on the label 10. The second shrink film 14 may be opaque, transparent or translucent as desired. By providing the printing 20 on the first or second face 16, 18 at the lamination interface, the printing 20 is protected from scuffing during the labeling process as well as during packing, shipping, shelf stocking and subsequent use by the consumer. Of course, since first shrink film 12 is transparent, the adhesive 22 must be a clear drying adhesive. Such clear drying adhesives are available in a number of forms including U.V. adhesive, solventless adhesive and EB curable adhesive. Typically the adhesive is applied at a rate of approximately 300,000 square inches per pound.

After lamination the label 10 includes two exposed faces 24, 26. An optional antistatic coating 28 may be provided on one or both of the exposed faces 24, 26. The antistatic coating 28 is of a clear drying formulation. The antistat coating 28 is applied at the rate of about 500,000 square inches per pound. One possible antistatic coating 28 has a formulation comprising from about 2.0-6.0% anti-static agent (e.g. Armac 1019, available from Akzo Nobel Surface Chemistry, LLC of Chicago, Ill.), 0-0.3% defoamer and the remainder is solvent. This solvent may be selected from a group consisting of water, alcohol and any mixture thereof. A typical alcohol utilized as a solvent in an anti-static formulation of the type being described is isopropyl alcohol.

In accordance with yet another aspect of the invention, an offset powder dusting or layer 30 is applied over the anti-static coating 28 and/or directly to one or both of the exposed faces 24, 26 of the printing stock 12. The offset powder dusting or layer 30 may be substantially any powder exhibiting the desired lubricating properties so as to aid in separating the individual stacked labels so that they may be fed easily through the labeling equipment. Useful offset powders include but are not limited to cornstarch, baby powder, talc and mixtures thereof. For example, #375 coated 30-micron powder available from Oxy-Dry of Itasca, Ill., may be utilized as the offset powder.

The anti-static coating 28 and the offset powder layer 30 on, for example, the upper face 24 of the label 10 provide sufficient lubricating and anti-static properties to allow ready separation of stacked labels 10 in existing cut-and-stack labeling equipment. Thus, the labels 10 have the necessary stiffness and anti-static properties to operate efficiently and reliably in existing cut-and-stack labeling equipment. Further, the labels 10 beneficially provide the properties desired by packaged goods manufacturers utilizing plastic containers. Specifically, the labels 10 are 100% waterproof, extremely durable by being resistant to scuffing and product deterioration and able to withstand drops of six feet or more without tearing, and are aesthetically pleasing to the consumer's eye and touch for the foreseeable useful life of the container. Further, the labels 10 may be manufactured in a cost effective manner competitive in today's marketplace.

The method of producing cut-and-stack labels 10 comprises printing indicia on one or both faces 16, 18 of the shrink films 12, 14, laminating the shrink films 12 and 14 together to form a sheet with the printed indicia provided along the lamination interface, dusting at least one exposed face 24, 26 of the sheet with an offset powder 30 and finishing the cut-and-stack labels 10. The method may also include the optional step of applying an antistat to at least one of the exposed faces 24, 26 of the sheet. Where the antistat coating 28 is applied, the offset powder 30 may be dusted over the antistat coating if desired.

More specifically describing the production method, pre-pressed stage steps include making the printing plates, printing inks and selecting the polymer film for the printing stock/film.

The printing press stage steps include feeding the polymer film printing stock 16, 18 in continuous web form longitudinally into the printing press. Specifically, as is known in the art, the printing press is composed of an unwind unit for feeding stock into the press, a number of print units and a rewind unit for delivering printed stock out of the press. Each print unit consists of (a) a number of printing cylinders for feeding the printing stock through the press, for applying ink to the printing plate and for transferring ink to the front face of the stock and (b) a drying and/or curing unit that dries the ink, coating or adhesive utilizing either hot air drying or ultraviolet curing.

At the first and each subsequent printing unit, ink of a particular color is applied to the print face 18 of the shrink film 14. Through the application of ink at each printing unit, the printed image of the label is created.

At the second to last printing unit, the adhesive 22 is applied to the face 18 of the shrink film 14 over the printed image. The shrink film 14 is then nipped to a web of clear shrink film 12 that is fed into the printing press for laminating to the shrink film 14. Following the nip, the laminated/printed sheet or roll is staged for twenty-four hours to allow for proper curing.

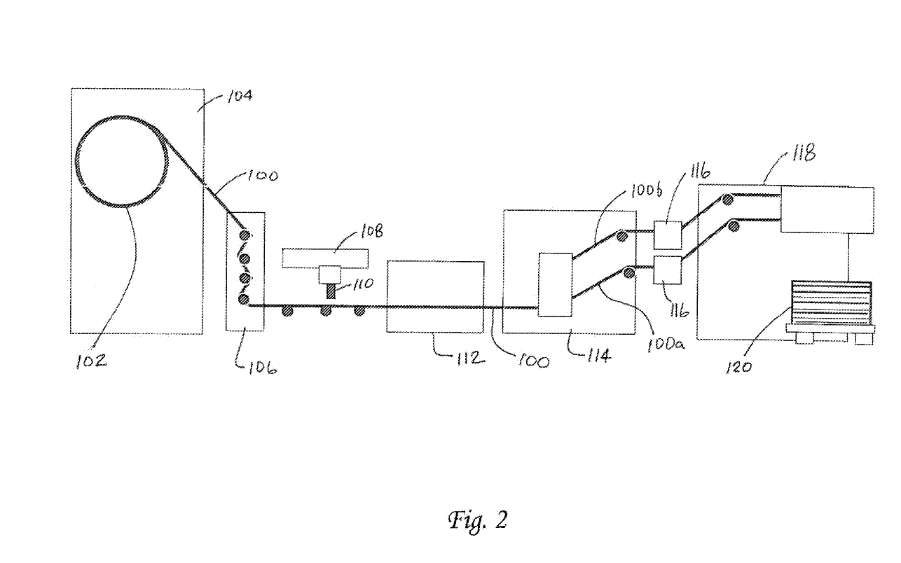

Following curing the laminated/printed supply roll 102 is webbed for further processing. More specifically, as illustrated in FIG. 2 the continuous web 100 is fed from the supply roll 102 on the web feeder 104 (such as a 50″ KTI unwind machine) through the web guide 106 to the auto-spray unit 108. Auto-spray unit 108 includes a series of spray jets 110 for evenly applying an antistat formulation over the entire width W of the continuous web of printing stock 100. Preferably, the antistat formulation is a wax less formulation particularly suited for spray jet application. A particularly useful formulation comprises 1.4% antistat solution RAW 104693-540, 10.0% isopropyl alcohol, 3.0% RMAC 1019 antistatic agent and 85.60% water. The continuous web 100 is then fed through a drying tunnel 112 in order to dry the antistat on the surface of the web. At no point in the drying process is the web 100 heated to a temperature that would cause the films 12, 14 to shrink. Next the continuous web 100 is fed through an angle bar system 114 such as a VITS angle bar slitter and converter. In this device the continuous web 100 is slit in a longitudinal direction so as to provide two narrow webs 100a, 100b having a width w where w=W/2. The two narrow webs 100a, 100b are vertically stacked and then fed to two separate powder boxes 116. There each of the narrow webs 100a, 100b is dusted with an offset powder 30 such as cornstarch, baby powder, talc or mixtures thereof. The dusted narrow webs 100a, 100b are then fed to a sheeting device such as a VITS sheeter. There the stacked, narrow webs 100a, 100b are cut into sheets of a predetermined length that are stacked and staged on a skid for finishing as illustrated by reference number 120.

Each skid of sheets 120 is jogged, inspected, separated into increments of 1000 sheets, cut, banded and packaged in a box. The sheets are jogged in a jogging machine that vibrates the sheets so that the sheets are aligned to each other for accurate cutting. At the jogging machine, separation of the sheets into lift counts of one thousand sheets is determined using a weighing scale.

After jogging, the lift of one thousand sheets is transferred via air tables to a cutting machine that cuts the one thousand sheets into bundles of one thousand individual labels 10. After the cutting machine, the bundled one thousand individual labels 10, now in cut-and-stacked form, are packaged together and placed in a box for storage and shipment. A bundle of labels 10 can be packaged in a number of ways including banded or string tied.

The finished cut-and-stack labels 10 are shipped to the packager where they are loaded into the cut-and-stack labeling equipment. The cut-and-stack labels 10 are then individually fed and positioned on a container to be sealed. Significantly, the positioning is completed using hot melt glue applied by a non-contact spray system such as, but not limited to, a Robatech Gluing Technology system with SX Series™ and/or Coating Head ETV Series™ dispensing guns or a Nordson Corporation system with PatternJet™ and/or PatternCoat™ dispensing guns. Subsequent to positioning, the label is subjected to heating so as to cause the shrinking of the cut-and-stack label 10 to the contour of the container. The printing 20 on the cut-and-stack label may, of course, be adjusted for any graphic distortion resulting from the shrinking process. For certain applications the cut-and-stack label 10 may be shrunk around the neck and/or cap of the container so as to provide tamper evident packaging if desired. Advantageously, for the first time, the cut-and-stack label 10 of the present invention allows a packager to apply shrink film packaging and labels utilizing existing cut-and-stack labeling equipment.

In summary, numerous benefits results from employing the present invention. Attempts in the past to product cut-and-stack shrink labels using non-shrink film materials proved to be unsuccessful. While labels made from non-shrink films can be applied using cut-and-stack label equipment with roller applied hot melt systems, the inconsistent and unpredictable shrink properties of these films and materials were proved to be unsatisfactory and unreliable. Typically, continuous roll shrink labels have been produced in a thickness of 1.89 mil or less, and labels of these thicknesses are not suitable to be applied using cut-and-stack label equipment. The present invention is a cut-and-stack label produced by combining shrink film materials in a thickness typically between about 2.0 mil and about 3.6 mil in a unique process which eliminates static, and the present invention is applied to containers on cut-and-stack label equipment with spray, non-contact spray hot melt glue systems.

Shrink film materials react to steam or forced hot air in temperature ranges of 185° F. to 285° F. Cut-and-stack label equipment with direct contact roller hot melt glue systems apply labels to containers using hot melt glues in a temperature range of 265° F. to 305° F., and the glue rollers in a temperature range of 265° F. to 305° F. Hot melt glues and rollers in these temperature ranges will cause shrink film materials to distort and shrink before being applied to the container. To overcome this problem, the invention employs non-contact spray hot melt glue systems which allow for the application of hot melt glues without direct contact of a heated roller against the supply of labels. A non-contact hot melt system allows this uniquely produced shrink label to be properly and efficiently applied using cut-and-stack label equipment.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

1. A method of labeling a container, comprising:
feeding a cut-and-stack label made from at least one shrink film;
positioning said cut-and-stack label on said container after applying an adhesive to said cut-and-stack label using a non-contact spray hot melt glue system; and
shrinking said cut-and-stack label to said container.

2. The method of claim 1 including using a cut-and-stack label having a thickness of between about 2.0 mil and about 3.6 mil.

3. A cut-and-stack label, comprising:
a cut-and-stack sheet sized for (a) feeding by cut-and-stack labeling equipment and (b) labeling an individual container, said cut-and-stack sheet including;
a first shrink film layer having a first face;
a second shrink film layer having a second face;
said first face of said first shrink film layer being laminated to said second face of said second shrink film layer; and
printing provided on at least one of said first face and said second face.

4. The label of claim 3, wherein an exposed face of said cut-and-stack sheet includes an anti-stat coating.

5. The label of claim 3, wherein an exposed face of said cut-and-stack sheet includes a dusting of an off-set powder.

6. A method of producing cut-and-stack labels, comprising:
printing indicia on a first face of a first shrink film;
laminating said first face of said first shrink film to a second face of a second shrink film to form a sheet;
applying an antistat to at least one exposed face of said sheet;
dusting said at least one exposed face of said sheet with an offset powder; and
finishing said cut-and-stick labels.

7. The method of claim 1 wherein said feeding step includes feeding said cut-and-stack label from a supply of cut-and-stack labels without directly contacting said cut-and-stack label or said supply of cut-and-stack labels with any type of hot glue applicator so as to avoid shrinking and distorting said cut-and-stack labels prior to shrinking said cut-and-stack labels to any container.
